(19) United States
(12) Patent Application Publication
(10) Pub. No.: US 2010/0267563 A1
(43) Pub. Date: Oct. 21, 2010

(54) METHOD OF IMPROVING THE GROWTH OF A PLANT

(75) Inventors: Domingos Pedroni, Stein (CH); Anke Buchholz, Stein (CH); Anne Waller, Berkshire (GB); Werner Reiner, Stein (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignees: SYNGENTA CROP PROTECTION, INC., Greensboro, NC (US); SYNGENTA LIMITED, Guildford, Surrey (GB)

(21) Appl. No.: 12/665,346

(22) PCT Filed: Jun. 18, 2008
(86) PCT No.: PCT/EP2008/004886

§ 371 Date: Jun. 24, 2010

(30) Foreign Application Priority Data
Jun. 21, 2007 (EP) 07012157.9

(51) Int. Cl. A01N 43/88; A01N 43/54; A01N 43/40; A01N 43/50; A01N 43/828; A01N 43/78; A01N 43/80; A01N 43/56; A01N 43/32; A01N 43/08; A01P 21/00

(52) U.S. Cl. 504/223; 504/243; 504/244; 504/253; 504/261; 504/266; 504/269; 504/282; 504/288; 504/294

(57) ABSTRACT

A method of improving the growth of a plant comprising applying to a plant, plant propagation material or locus thereof a composition comprising a product, which comprises microcapsules which themselves comprise (a) a polymeric shell; and (b) a core which comprises a dispersed solid active ingredient compound wherein the compound is one or more of a neonicotinoid, fipronil, a strobilurin, carboxin, acibenzolar-S-methyl, and probenazole.

The present invention relates to a method for improving the growth of a plant.

Classes of compounds and agents are known to improve and/or support the growth of a plant through, for example, uptake, assimilation and/or transport of plant nutrients.

For example, WO 0126468, WO02051246, and WO03096811 describe certain agrochemical compounds for improving the growth of a plant. The compounds are described to demonstrate these characteristics in addition to their pesticidal characteristics.

The improvement in the growth of the plant may be achieved through a number of known mechanisms which affect germination, root growth & establishment, tolerance to stress factors, such as extreme temperatures, drought or salt, and nutrient absorption.

Further, US2005164882, WO2005009128, WO2006015697, WO06133827 and WO06131222 describe advantages of using such compounds on a plant, such as ability to reduce the phytotoxicity caused by herbicides and enhance the stress tolerance of plants.

Accordingly, methods are sought which would further improve the characteristics of such compounds, not only as pesticides, but for improving the growth of a plant, especially in the absence of pest or pathogen pressure on the plant. Especially useful would be if the methods could help reduce the amount of in-field cultivation and chemical application to plants during growth; were safe and easy to use; could be carried out with reduced exposure of farmers and surrounding land and water, and non-target plants and animals to toxic pesticides.

Applicant has found that a defined microcapsule technology in combination with compounds known to improve the growth of a plant provides an unexpected enhancement of the compounds' characteristics.

Accordingly, in a first aspect the present invention provides a method of improving the growth of a plant comprising applying to a plant, plant propagation material or locus thereof a composition comprising a product, which comprises microcapsules which themselves comprise

(a) a polymeric shell; and
(b) a core which comprises a dispersed solid active ingredient compound
wherein the compound is one or more of a neonicotinoid, fipronil, a strobilurin, carboxin, acibenzolar-5-methyl, and probenazole.

In a preferred embodiment, the core comprises (i) a solid active ingredient compound dispersed in a matrix and (ii) a water-immiscible liquid characterised in that the matrix is distributed non-continuously throughout the water-immiscible liquid;

wherein the active ingredient compound is one or more of a defined neonicotinoid, fipronil, a strobilurin, carboxin, acibenzolar-5-methyl, and probenazole.

Microcapsule technology has been in existence for a number of years. Microcapsules have a variety of uses, especially for containing dyes, inks, chemical reagents, pharmaceuticals, flavouring materials, and more especially agrochemicals, that is fungicides, bactericides, insecticides, herbicides and the like.

Microencapsulated formulations of agrochemicals may be exploited in a wide range of applications both in crop protection and professional products outlets, and may be applied via a variety of methods such as foliar sprays, soil application and as seed treatments.

In commercial use, agrochemical products are subject to a range of environmental factors which result in a reduction in efficacy of the formulation, including run-off and leaching from soil (which may lead to groundwater contamination), rainfastness and wash-off from seeds; water-soluble active compounds are particularly susceptible to such losses.

The microcapsule defined in the first aspect of the invention is useful for improving the characteristics of the active ingredient compounds defined in the first aspect, especially in relation to improving the growth of a plant, in particularly in the absence of pest and/or pathogen pressure on the plant. The microcapsule defined in the first aspect provides for controlled release of the active ingredient compounds, and thereby controls the release of the active ingredient compounds defined in the first aspect into soil with a high moisture content as a result of heavy rainfall or excessive irrigation. A further advantage is that products comprising such microcapsules can also reduce the amount of such an active ingredient compound that is leached to lower soil levels by heavy rainfall or irrigation.

Several technologies are commonly known as being useful in the production of microcapsules (for example as described in chapter 4 of “Controlled Delivery of Crop Protection Agents”, pub. Taylor and Francis, London 1990). One such technology of particular utility for the encapsulation of agrochemicals is interfacial polymerisation in which the walls of the microcapsules are generally formed of polymeric material produced by a polymerisation reaction which preferably takes place at the interface between two phases, usually an aqueous phase and a water-immiscible organic phase. Thus, they may be produced from a water-in-oil emulsion or more usually an oil-in-water emulsion.

Microcapsules which comprise, in the organic phase, suspensions of solid biologically active compounds in organic solvents or liquid biologically active compounds are known (e.g. as described in patent documents WO 95/13698, EP 0730406, U.S. Pat. No. 5,993,842, U.S. Pat. No. 6,015,571 and WO 01/68234, the contents of which are fully incorporated herein by reference).

Processes for the microencapsulation of water-soluble biologically active compounds are also known, but in these the biologically active compound is generally dissolved in water or a water-miscible solvent prior to encapsulation.

It has now been found that it is possible to encapsulate an active ingredient compound defined in the first aspect which is dispersed in a substantially water-immiscible phase, in which the compound is dispersed in a (non-continuous) matrix which is at least partially solid and which is distributed throughout the microcapsules.

In one particular embodiment, the (non-continuous) matrix is formed via an interfacial polymerisation of an oil-in-water emulsion, in which an active ingredient compound defined in the first aspect is dispersed within the oil. Surprisingly, carrying out said interfacial polymerisation results in the formation of a polymer (non-continuous) matrix which is distributed throughout the microcapsules, rather than being restricted to the interface, as is commonly taught in the prior art.

There are several problems which must be overcome for the successful encapsulation of a suspension of solid particles within a microcapsule formed by interfacial polymerisation of an oil-in-water emulsion.

Firstly, a stable suspension of the solid in a substantially water-immiscible liquid must be produced. If dispersants or surfactants are used, they must not interfere with any further processes of dispersion used in making microcapsules.

Secondly, the suspension must be dispersed in water to produce stable, well dispersed droplets. For biologically active substances, it is preferable to have very small droplets of liquid dispersed in water so as to present a high surface area of the resulting microcapsules. To produce very small droplets requires high shear forces which would tend to break down the droplets and/or release the solid from suspension. Surfactants are usually required to achieve good dispersion and stable droplets.

Thirdly, the presence of one or more surfactants may make the dispersed droplet system unstable and the phenomenon of phase inversion may occur, i.e. water forms small droplets within the liquid; a water-in-oil emulsion.

Fourthly, the solid suspended in the water-immiscible liquid is liable to migrate to the aqueous phase, particularly when emulsifying surfactants are used.

The last three of these problems is even more challenging to overcome for the encapsulation of water-soluble biologically active compounds, and it has been found that modifications are required to the procedures described in patent documents WO 95/13698, EP 0730406, U.S. Pat. No. 5,993,842, U.S. Pat. No. 6,015,571, US 2003/0119675 and JP 2000247821 for the encapsulation of suspensions of water-insoluble compounds.

It has now been found that it is possible to produce microcapsules which comprise an active ingredient compound defined in the first aspect dispersed in a (non-continuous) matrix which is at least partially solid and which is distributed throughout the microcapsules. Moreover it has been found that the capsule technology can be varied over an extremely wide range resulting in controlling the characteristics of the active ingredient compounds.

One very suitable technique for the formation of said microcapsules is interfacial polymerisation via an oil-in-water emulsion; surprisingly, this results in the formation of a polymer (non-continuous) matrix which is distributed throughout the microcapsules, rather than being restricted to the interface, as is commonly taught in the prior art.

The microcapsules may be produced using the following methodology:

Step 1—producing the active ingredient compound defined in the first aspect with the required particle size, suitably by a milling process. A suitable Volume Median Diameter [VMD] particle size of the solid is 0.01-50 μm; more suitably the lower limit is 0.5 μm and even more suitably the lower limit is 1.0 μm; more suitably the upper limit is 10 μm and even more suitably the upper limit is 5 μm.

Step 2—suspending the active ingredient compound defined in the first aspect in a substantially water-immiscible liquid. The liquid is preferably a poor solvent for the solid, i.e. it will not dissolve significant quantities of the solid.

The liquid preferably contains a dispersant capable of keeping the solid in the liquid but which does not allow the solid to be extracted into the water when the suspension is dispersed into water. In addition, when the suspension is added to water, the dispersant must not allow phase inversion to occur.

Alternatively, the procedures of steps 1 and 2 may be varied by performing a milling process to reduce the particle size of the active ingredient compound defined in the first aspect, after the compound has been suspended in the substantially water-immiscible liquid (media milling).

Step 3—a physical dispersion of the organic phase in an aqueous phase is prepared. To obtain the appropriate dispersion, the organic phase is added to the aqueous phase, with stirring. A suitable dispersing means is employed to disperse the organic phase in the aqueous phase. Selection of dispersion process and apparatus will depend upon the desired particle size of the emulsion (and ultimate product) to be produced. One suitable means of dispersion is typically a high shear rotor/stator device (such as a laboratory Silverson™ machine) for small (<10 micron VMD products) but other means can be employed such as Cowles™ dissolvers, simple mixing devices for larger particle sizes and even high pressure homogenisation equipment. Choice of such equipment is within the scope of one skill in the art. A suitable means may be any high shear device so as to obtain a desired droplet (and corresponding microcapsule particle) size within the range from about 1 to about 200 μm. A suitable means may be any high shear device so as to obtain a desired droplet (and corresponding microcapsule particle) size within the range from about 1 to about 200 μm; suitably from about 1 to 150 μm; more suitably from about 1 to about 50 μm; and most suitably from about 3 to about 50 μm, VMD. Once the desired droplet size is obtained, the dispersion means is discontinued. Only mild agitation is required for the remainder of the process. The organic phase comprises the active ingredient compound defined in the first aspect suspended in the substantially water-immiscible liquid to be encapsulated prepared as described above in steps 1 and 2. The aqueous phase comprises water and at least one emulsifier and/or protective colloid.

Clearly there is a relationship between the particle size of the active ingredient compound defined in the first aspect and the particle size of the microcapsules; in order to obtain control over the release rate of the active ingredient compound, the VMD ratio of the particle size of this compound to that of the microcapsules will be typically of the value 1:5; suitably in the range 1:3 to 1:100; more suitably 1:5 to 1:20.

In order to obtain the microcapsules, the organic phase and/or the aqueous phase must contain one or more materials which can react to form a polymer. In one preferred embodiment, the organic phase contains at least one diisocyanate and/or polyisocyanate, whilst the aqueous phase contains at least one diamine and/or polyamine. In the situation where at least one diamine and/or polyamine is included in the aqueous phase, this component is added to the aqueous phase after the formation of the oil-in-water emulsion as described above in step 3.

Step 4—at least one diamine and/or polyamine is added to the oil-in-water emulsion through the aqueous phase, maintaining mild agitation throughout. Stirring is continued typically for 30 minutes to 3 hours until the formation of the (non-continuous) matrix is complete. The reaction temperature is generally in the range from about 20° C. to about 60° C. In the situation where approximately equimolar amounts of isocyanate and amino groups are present, the reaction temperature is preferably from about 20° C. to about 40° C., and even more preferably from about 20° C. to about 30° C. In the situation where an excess of isocyanate groups are present, the reaction temperature is preferably from about 30° C. to about 60° C., and even more preferably from about 40° C. to about 50° C. Reaction times in excess of 3 hours combined with temperatures of 60° C. or above are not recommended; such conditions have been utilised for the encapsulation of suspensions of water-insoluble compounds (US 2003/0119675 and JP 2000247821) but it has been found that such conditions arc not suitable for the formation of die microcapsules useful in the present invention, as they result in poor encapsulation efficiency (the water-solubility of the active compounds increases with increasing temperature, resulting in excessive quantities of the active compound transferring into the aqueous phase).

To form a (non-continuous) matrix, many other microencapsulation techniques are possible, including:

(i) Preparation of a microcapsule in which a monomer is present in the disperse phase and is caused to undergo polymerisation to form the (non-continuous) matrix. Such monomers should be essentially water immiscible and typically comprise a vinyl reactive monomer, for example, C1-C16 alkyl esters of acrylic and methacrylic acid such as ethyl hexyl acrylate and ethyl hexyl methacrylate. Cross-linking may also be introduced by choice of an appropriate acrylate or methacrylate monomer such as glycidyl methacrylate;
(ii) preparation of a microcapsule in which the active ingredient compound defined in the first aspect is dispersed within a liquid in which a reagent is dissolved, and in which the liquid and reagent are caused to react to form the (non-continuous) matrix. Such effects may be achieved by two reactive species, as are required to produce a polyurethane. These include organic liquid soluble polyols to react with a suitable isocyanate. When the isocyanate reactive species has sufficient functionality, the polyol may contain just one polymerisable hydroxyl group. Many chemistries qualify including alcohols and surfactant products derived from alkoxylation processes (including ethylene oxide, propylene oxide and butylene oxide or mixtures thereof. When the isocyanate has less functionality or where high degrees of cross linking are desired within the (non-continuous) matrix, the polyol component may comprise more than one polymerisable OH (hydroxyl) functional compounds, suitably comprising two or more hydroxyl groups, per molecule on average. The polymerisable, hydroxyl functional compounds may be aliphatic and/or aromatic. The polymerizable, hydroxyl functional compounds may be straight, cyclical, fused, and/or branched. Particular polymerizable hydroxyl functional compounds include at least one diol, at least one triol, and/or at least one tetrol. Any of these polyol compounds may be monomeric, oligomeric, and/or polymeric as desired. If oligomeric and/or polymeric, the polyol(s) may be selected from one or more hydroxyl functional polyethers, polyesters, polyurethanes, polyacrylics, epoxy resins, polyamides, polyamines, polyureas, polysulfones, combinations of these, or the like. Polyether polyols such as the polyalkylene ether and polyester polyols are also suitable and these are commercially available at relatively low cost and are hydrolytically stable.

Suitable polyalkylene ether polyols include poly(alkylene oxide) polymers which are essentially water immiscible and organic soluble, such as poly(ethylene oxide) and poly(propylene oxide) polymers and copolymers with terminal hydroxyl groups derived from polyhydric compounds, including diols and triols; for example, ethylene glycol, propylene glycol, 1,3-butane diol, 1,4-butane diol, 1,6-hexanediol, neopentyl glycol, diethylene glycol, dipropylene glycol, pentaerythritol, glycerol, diglycerol, trimethylol propane and similar low molecular weight polyols. Suitable commercially available polyether polyols include those sold under the trade name Voranol® (The Dow Chemical Company).

The polyester polyols which are suitable in accordance with the invention include known polycondensates of organic dihydroxy and optionally polyhydroxy (trihydroxy, tetrahydroxy) compounds and dicarboxylic and also optionally polycarboxylic (tricarboxylic, tetracarboxylic) acids or hydroxycarboxylic acids or lactones. Instead of the free polycarboxylic acids it is also possible to use the corresponding polycarboxylic anhydrides or corresponding polycarboxylic esters of lower alcohols to prepare the polyesters such as, for example, phthalic anhydride. Examples of suitable diols are ethylene glycol, 1,2-butanediol, diethylene glycol, triethylene glycol, polyalkylene glycols, such as polyethylene glycol, and also 1,2- and 1,3-propanediol, 1,4-butanediol, 1,6-hexanediol, neopentyl glycol or neopentyl glycol hydroxypivalate. Examples of polyols having 3 or more hydroxyl groups in the molecule, which may be used additionally, if desired, include trimethylolpropane, trimethylolethane, glycerol, erythritol, pentaerythritol, di-trimethylolpropane, dipentaerythritol, trimethylol-benzene and trishydroxyethyl isocyanurate.

A particularly suitable class of polyols useful in the compositions, coatings and methods of the invention are the water insoluble phthalic anhydride based polyester-ether polyols which are described, for example, in U.S. Pat. No. 6,855,844 which is incorporated by reference herein. Suitable commercially available phthalic anhydride based polyester-ether polyols include the “Stepanpols”® (Stepan Company).

Other relatively simple feedstocks include natural products that contain reactive hydroxyl groups such as castor oil. These systems require the addition of a suitable catalyst that may be added as needed to any of the phases in the formulation. Suitable catalysts are well known in the art but include organometal catalysts such as dibutyl tin dilaurate and tertiary amines such as triethylamine and triisopropanolamine; and

(iii) preparation of a microcapsule wherein a (non-continuous) matrix-forming compound is caused to separate within the microcapsule by removal of a volatile solvent for that compound. This may be achieved by firstly preparing a dispersion of the active ingredient compound of the first aspect in a solution of a water insoluble (non-continuous) matrix forming polymer and a water immiscible volatile solvent for that water insoluble (non-continuous) matrix forming polymer, secondly forming an emulsion of this water-immiscible mixture in water, stabilising that emulsion by an appropriate technique and then removing the volatile solvent by a suitable evaporation process, yielding a dispersion in water of microcapsules containing the active ingredient compound defined in the first aspect distributed throughout a (non-continuous) matrix of the water insoluble polymer. The stabilisation of the intermediate emulsion may be achieved by any suitable microencapsulation process, such as an interfacial polycondensation by the routes well known and outlined above but also by such routes as identified in U.S. Pat. No. 5,460,817, where the technology is identified as being useful for water insoluble (and oil soluble) biologically active compounds such as chlorpyrifos and trifluralin but does not refer to utility for dispersions in an oil or polymer of an active ingredient compound defined in the first aspect.

Suitably the matrix is a polymer which is a polyurea, a polyamide or a polyurethane or is a mixture of two or more of these polymers; more suitably the matrix is a polyurea.

In the preparation of such microcapsules, it is naturally assumed that the substantially water immiscible liquid used for the preparation of the dispersion of the active ingredient compound defined in the first aspect will be essentially retained within the microcapsule (unless removed deliberately by evaporation as discussed above). Undesired loss of solvent may alter (and destabilise) the capsule structure and release characteristics. One preferred embodiment of the capsule is where the water-immiscible liquid does not migrate into the water phase and, moreover, is involatile such that drying operations on the aqueous compositions do not result in solvent loss and thus alteration of the desired capsule composition.

As described in the first aspect, the improvement in growth is demonstrated with the present capsule technology especially with certain compounds defined in the first aspect.

The concentration of the active ingredient compound defined in the first aspect is suitably from 0.1-70% [more suitably 0.1-65%] by weight of the microcapsule.

For those cases in which the active ingredient compound defined in the first aspect is suspended in a substantially water-immiscible liquid, said liquid may be any liquid which does not dissolve the compound to any appreciable extent but is a sufficiently good solvent to dissolve the reagents or prepolymers used to form the (non-continuous) matrix. Suitably the water-solubility of the liquid under ambient conditions [typically 20° C.] is approximately 5000 ppm by weight or less.

Suitable examples of such liquids are aromatic organic compounds such as xylenes or naphthalenes, eg. Solvesso® 200; aliphatic organic compounds such as alkyl esters, eg. Exxate® 700-Exxate® 1000, Prifer® 6813; paraffinic compounds, eg. the Norpar® & Isopar® ranges of solvents; alkyl phthalates, such as diethyl phthalate, dibutylphthalate and dioctylphthalate; alcohols, such as isopropyl alcohol; ketones, such as acetophenone and cyclohexanone; mineral oils, eg. Cropspray® 7N or 11N; vegetable or seed oils, such as rapeseed oil; and alkylated seed oils. The liquid may be a mixture of more than one compound.

Furthermore the liquid in which the compound of the first aspect is suspended may in itself be or comprise a second biologically active compound, such as an agrochemical.

The phase volumes of the disperse organic phase and the continuous aqueous phase may be varied within a wide range; typically the organic phase is present at 5 to 70% by weight; suitably from 15 to 70% by weight; and more suitably from 15 to 50% by weight based on the entire formulation.

The liquid suitably contains a dispersant. The exact choice of dispersant(s) will depend on the choice of the compound of the first aspect and the liquid but particularly suitable dispersants are those which act by steric hindrance and are active only at the solid/organic liquid interface and do not act as emulsifying agents. Such dispersants are suitably made up of (i) a polymeric chain having a strong affinity for the liquid and (ii) a group which will adsorb strongly to the solid.

Examples of dispersants which may be used in microcapsules containing the compound of the first aspect suspended in a liquid [and which are generally polymeric] are given in WO 95/13698, and include products available under the tradenmaes Hypermer®, Atlox®, Agrimer® and Solsperse®.

In general, the range of dispersant concentration used is from about 0.01 to about 10% by weight based on the organic phase, but higher concentrations may also be used.

For the successful encapsulation of suspensions of a compound of the first aspect the choice of the liquid/dispersant combination within the microcapsules is particularly critical. Suitable systems include Solvesso® 200 and Solsperse®17000; rapeseed oil and Solsperse® 17000; a Norpar® 15/Prifer® 6813 mixture with Z190-165™; and Cropspray® 7N or 11N with one or more dispersants selected from Atlox® 4912, Atlox® LP1, Agrimer® AL22 and Agrimer® AL30. Such combinations are particularly suitable when the compound of the first aspect is thiamethoxam.

In general, the surfactant or surfactants in the aqueous phase of the microcapsule suspension are selected from anionic, cationic and non-ionic surfactants with an HLB range from about 10 to about 16 that is high enough to form a stable oil-in-water emulsion; non-ionic surfactants are particularly suitable. If more than one surfactant is used, the individual surfactants may have HLB values lower than 10 or higher than 16. However, when combined together the overall HLB value of the surfactants may be in the range 10-16. Suitable surfactants include polyethylene glycol ethers of linear alcohols, ethoxylated nonylphenols, tristyrylphenol ethoxylates, block copolymers of propylene oxide and ethylene oxide, and polyvinyl alcohols. Polyvinyl alcohols are particularly suitable.

In general, the range of surfactant concentration in the process is from about 0.01 to about 10% by weight, based on the aqueous phase, but higher concentrations of surfactant may also be used.

Additionally, a protective colloid may also be present in the aqueous phase. This must adsorb strongly onto the surface of the oil droplets. Suitable protective colloids include polyalkylates, methyl cellulose, polyvinyl alcohols, mixtures of polyvinyl alcohols and gum arabic, and polyacrylamides. Polyvinyl alcohols are particularly suitable.

There should be sufficient colloid present to afford complete coverage of the surfaces of all the droplets of the organic liquid. The amount of protective colloid employed will depend on various factors, such as molecular weight and compatibility. The protective colloid may be added to the aqueous phase prior to the addition of the organic phase, or can be added to the overall system after the addition of the organic phase or the dispersion of it. The protective colloid is generally present in the aqueous phase in an amount of from about 0.1 to about 10% by weight of the aqueous phase.

Where separate emulsifiers and colloid stabilisers are used in the aqueous phase, the emulsifier should not displace the protective colloid from the surface of the droplets of the organic liquid.

In the situation in which the microcapsules are prepared via an interfacial polycondensation reaction, the organic phase and/or the aqueous phase contains one or more materials which may react to form the polymer (non-continuous) matrix. In one preferred embodiment, the organic phase contains at least one diisocyanate and/or polyisocyanate, whilst the aqueous phase contains at least one diamine and/or polyamine.

Any diisocyanate or polyisocyanate, or mixtures thereof, may be employed, provided that it is soluble in the liquid chosen for the organic phase. Where aromatic liquids are used, aromatic isocyanates such as isomers of tolylene diisocyanate, isomers and derivatives of phenylene diisocyanate, isomers and derivatives of biphenylene diisocyanates, and/or polymethylenepolyphenyleneisocyanates (PMPPI) are suitable. Where aliphatic liquids are used, aliphatic isocyanates are suitable, for example aliphatic acyclic isocyanates such as hexamethylenediisocyanate (HMDI), cyclic aliphatic isocyanates such as isophoronediisocyanate (IPDI) or 4,4′ methylenebis(cyclohexyl isocyanate), and/or trimers of HMDI or IPDI and the like. Polymeric polyisocyanates, biurets, blocked polyisocyanates, and mixtures of polyisocyanates with melting point modifiers may also be used. MDI is a particularly preferred polyisocyanate. Should other properties be desired from the isocyanate such as increased flexibility, then pegylated derivatives may be employed wherein part of the isocyanate is reacted with a suitable polyol. Such techniques and chemistries are well known in the art.

The concentration of the isocyanate(s), and the ratio(s) where more than one isocyanate is used, is/are chosen so as to obtain the desired release rate profile for the particular end application. The concentration of the isocyanate(s) must also be high enough to form a (non-continuous) matrix dispersed throughout the microcapsules. In general, the isocyanate(s) will comprise from about 5 to about 75%, more suitably from about 7 to about 30%, even more suitably from about 10 to about 25% and most suitably from about 10 to about 20%, by weight of the microcapsule.

The diamine or polyamine, or mixtures thereof, may be any such compound(s) which is/are soluble in the aqueous phase. Aliphatic or alicyclic primary or secondary diamines or polyamines are very suitable, such as ethylene-1,2-diamine, diethylenetriamine, triethylenetetramine, bis-(3-aminopropyl)-amine, bis-(2-methylaminoethyl)-methylamine, 1,4-diaminocyclohexane, 3-amino-1-methylaminopropane, N-methyl-bis-(3-aminopropyl)amine, 1,4-diamino-n-butane, 1,6-diamino-n-hexane and tetraethylenepentamine. Polyethyleneimines are also suitable.

The molar ratio of amine moieties to isocyanate moieties may be varied from about 0.1:1 to about 1.5:1. Suitably either (i) approximately equimolar concentrations of amine and isocyanate moieties are employed, with the molar ratio of amine to isocyanate moieties ranging from about 0.8:1 to about 1.3:1, in which case the wall formation reaction is suitably carried out at a temperature from about 20° C. to about 40° C., even more preferably from about 20° C. to about 30° C.; or (ii) a significant excess of isocyanate is present, with the ratio of amine to isocyanate moieties ranging from about 0.1:1 to about 0.35:1, in which case the wall formation reaction is preferably carried out at a temperature from about 30° C. to about 60° C., even more preferably from about 40° C. to about 50° C. In case (i), the reaction between approximately equimolar concentrations of amine and isocyanate moieties results in the formation of a polyurea (non-continuous) matrix which is distributed throughout the microcapsules. In case (ii), an initial reaction occurs between some of the isocyanate moieties and the amine moieties to fix a shell around the outside of the emulsion droplets, followed by hydrolysis and further reaction of the excess isocyanate moieties to form a (non-continuous) matrix which is distributed throughout the resultant microcapsules.

Other wall chemistries may be used, for example polyurethanes and polyamides, by appropriate selection of wall forming components. Suitable glycols for addition through the aqueous phase include those taught above and which are water soluble. These may also include simple polyhydroxylic glycols, for example, suitable diols are ethylene glycol, 1,2-butanediol, diethylene glycol, triethylene glycol, polyalkylene glycols, such as polyethylene glycol, and also 1,2- and 1,3-propanediol, 1,4-butanediol, 1,6-hexanediol, neopentyl glycol or neopentyl glycol hydroxypivalate. Examples of polyols having 3 or more hydroxyl groups in the molecule, which may be used additionally, if desired, include trimethylolpropane, trimethylolethane, glycerol, erythritol, pentaerythritol, di-trimethylolpropane, dipentaerythritol, trimethylol-benzene and trishydroxyethyl isocyanurate. Higher functionality may be employed by use of the various sugars such as fructose, dextrose, glucose and derivatives thereof. It is noted that glycols with suitable oil solubility characteristics may be introduced into the oil phase as part of the dispersion of the active ingredient compound of the first aspect whereby they can contribute not only to capsule wall formation but also (as indicated earlier) to (non-continuous) matrix formation. Mixtures of water soluble and oil soluble reactive hydroxyl containing compounds are also contemplated. Polyamides may be produced in a similar manner by selection of an appropriate acid feedstock (such as sebacoyl chloride). Mixtures, in any ratio, of polyureas, polyurethanes and polyamides are also contemplated. Therefore suitably the polymeric shell is a polymer which is a polyurea, a polyamide or a polyurethane or is a mixture of two or more of these polymers; more suitably the polymeric shell is a polyurea.

In a similar manner, oil soluble amines may be contemplated as being added to the oil phase prior to preparation of the aqueous dispersion and thereafter a suitable water dispersible isocyanate reactant may be added to complete the interfacial reaction.

By selection of microcapsule size, isocyanate chemistry and concentration, amine identity and the ratio of different isocyanate monomers and/or amines when more than one isocyanate monomer and/or amine is present, the release rate of the active ingredient compound of the first aspect can be varied from a half-life [T50; the time taken for 50% of the active ingredient to be lost from the capsule (i.e. released)] value of a few hours up to several months or years. It is surprising that such a wide range of release rates is achievable for the compounds of the first aspect, which are water soluble (i.e. has a solubility of between 0.1 to 100, preferably 0.5 to 50 g/L at 20 C) and it is particularly unexpected that extremely slow release rates into an aqueous sink are obtained.

Furthermore, mixtures of microcapsules with different characteristics, such as release rates, may be combined in a single formulation, to provide a desired plant growth effect.

The capsule compositions, as produced, will be dispersions in water. These microcapsules may be post-formulated, to stabilise them for long term shelf life storage, with anti-settling agents, which include water-soluble polysaccharides such as xanthan gum, water-insoluble polysaccharides such as microcrystalline cellulose and structured clays such as bentonites. Microcrystalline cellulose is a particularly suitable anti-settling agent.

Furthermore, it is possible to add biologically active compounds, such as an agrochemical, to the aqueous phase, either as solids, emulsions (either as an emulsion of a compound that is liquid at ambient temperature or as an emulsion of a solution of a biologically active compound in a suitable essentially water immiscible solvent) or as a solution in water or mixtures of the above. The biologically active compound added directly to the external aqueous phase may be the same compound as defined in the first aspect within the microcapsule.

Suitably the agrochemical in the aqueous phase has a water-solubility in the range of 0.1 to 100 g/l at 20° C.; more suitably the agrochemical in the aqueous phase is a neonictinoid insecticide; even more suitably it is acetamiprid, clothianidin, imidacloprid, thiacloprid or thiamethoxam; and most suitably it is thiamethoxam.

Where a biologically active compound is present in the aqueous phase, the concentration to of this compound may be varied within a relatively wide range. Generally the concentration of this compound will be between 0 and 50% by weight, based on the total aqueous phase.

Furthermore, it is possible to dry such water based compositions. This can be achieved by concentration of the water based composition (e.g. sedimentation, centrifugation) followed by a suitable drying technique such as drum drying. It may also be achieved by techniques such as spray-drying [including fluid bed agglomeration techniques and similar granulation processes] or, if the compounds are heat sensitive, freeze drying or atmospheric freeze drying. Spray drying techniques are preferred as they are fast and may conveniently be applied to dispersions such as the microcapsules defined in the first aspect. Production of dry product from a water based dispersion usually requires the addition of further inert components to protect the integrity of the capsules during the drying stage, or during storage and also to allow easy complete re-dispersion of the dry product back into water for application. Such inerts include, but are not limited to, essentially water soluble film-forming agents such as polyvinyl alcohols, polyvinylpyrrolidones and polyacrylic acids. Other ingredients may include surfactants, dispersants, sugars, lignosulfonates, disintegrants such as cross-linked polyvinylpyrrolidones and maltodextrins.

The dried products moreover, may contain other biologically active agents that are not encapsulated as described above for the compounds of the first aspect.

It is also possible to use a dried product directly without dilution into water. Such use may be as a granular product in rice cultivation, for use on cultivated turf and also as a feedstock for blending into fertiliser mixtures for subsequent application to soil, turf or other targets such as rice.

Suitably the dry product is granular.

Suitably the dry product is water-dispersible.

The wide range of release rates achievable with the technology of the first aspect allows exploitation in several applications, including traditional crop protection outlets both as a foliar or a soil applied product, for use on cultivated turf, and as a seed treatment.

The use of defined microcapsules also allows for an improvement in the growth of the plant, as well as for an extended period of biological control compared to non-encapsulated formulations and other encapsulated formulations, and for soil applied products the extent of leaching may also be reduced by the use of such microcapsules; the latter is particularly relevant for the active compounds disclosed in the first aspect, whereby their substantial water solubility renders them prone to leaching when applied in an non-encapsulated form. In the particular embodiment where the microcapsules are suspended in an aqueous medium comprising a suspension of non-encapsulated compound of the first aspect, both rapid knockdown activity and an extended period of biological control may be achieved, particularly for insecticides, as well as an improvement in the growth of the plant.

The microcapsule suspensions thus produced may be utilized in the normal fashion of such products, i.e. by packaging the suspension and ultimately transferring the suspension into a spray tank or other spray equipment, in which it is mixed with water to form a sprayable suspension. A range of application techniques may be utilised for the soil application of such microcapsules, including pre-planting and post-planting applications either as a dilute spray or as a more concentrated drench, including direct application into the planting hole. Application may also be made to seedling trays etc. prior to transplant. Alternatively, the suspension of microcapsules may be converted into a dry microcapsule product by spray drying or other known techniques and the resulting material packaged in dry form.

It will be appreciated that there are many embodiments to the capsule technology. In one embodiment it relates to a microcapsule formulation in which microcapsules comprise a compound of the first aspect dispersed in a (non-continuous) matrix which is at least partially solid and which is distributed throughout the microcapsules. In particular it relates to a product comprising microcapsules which themselves comprise

(a) a polymeric shell; and
(b) a core which comprises (i) the compound of the first aspect dispersed in a matrix and (ii) a water-immiscible liquid characterised in that the matrix is distributed non-continuously throughout the water-immiscible liquid.

Further embodiments and preferences are given below.

In an embodiment, the microcapsule is as described in WO 01/68234.

In an embodiment, the microcapsule formulation comprises microcapsules which comprise a compound of the first aspect dispersed in a (non-continuous) matrix which is at least partially solid and which is distributed throughout the microcapsules, in which the microcapsules are suspended in an aqueous phase during their formation.

In an embodiment, the microcapsule formulation is as described above wherein the compound of the first aspect is a solid at ambient temperature and is dispersed in an organic non-solvent within the capsules.

In an embodiment, the microcapsule formulation is as described above and a process as described above for making it in which a monomer is present in the disperse phase and is caused to undergo polymerisation to form the (non-continuous) matrix.

In an embodiment, the microcapsule formulation is as described above wherein a water immiscible liquid is a vinyl containing reactive monomer.

In an embodiment, the microcapsule formulation is as described above and a process as described above for making it in which the compound of the first aspect is dispersed within a liquid in which a reagent is dissolved, and in which the liquid and reagent are caused to react to form the (non-continuous) matrix.

In an embodiment, the microcapsule formulation is as described above wherein a water immiscible liquid is a reactant with a second reactive species by which a (non-continuous) matrix is formed.

In an embodiment, the microcapsule formulation is as described above in which the compound of the first aspect is dispersed within a substantially water-immiscible liquid which is retained within the microcapsule.

In an embodiment, the microcapsule formulation is as described above in which the substantially water-immiscible liquid is or comprises a second biologically active compound, such as an agrochemical.

In an embodiment, the microcapsule formulation is as described above in which one or more compounds of the first aspect is/are present in the continuous aqueous phase [either as a solid dispersion, a liquid dispersion or as a solution in the aqueous phase].

In an embodiment, the microcapsule formulation is as described above in which the compound of the first aspect which is present in the continuous aqueous phase is the same water-soluble biologically active compound as the one which is dispersed in the microcapsules.

In an embodiment, the microcapsule formulation is as described above wherein the formulation is water based (capsules dispersed in water).

In an embodiment, the microcapsule formulation is as described above where the formulation is a dry product, produced by a drying process such as spray drying or freeze drying or by a suitable concentration procedure and final drying.

In an embodiment, the microcapsule formulation is as described above where a (non-continuous) matrix-forming compound (suitably a polymer) is caused to separate within the microcapsule by removal of a volatile solvent for that compound.

In an embodiment, the (non-continuous) matrix of the microcapsule formulation is as described above can be prepared either before the capsule, during capsule preparation or after capsule preparation.

In an embodiment, the (non-continuous) matrix of the microcapsule formulation is as described above can be formed by an interfacial polycondensation reaction.

In an embodiment, the process is as described above in which at least one reagent for the polycondensation reaction is present in the dispersed [organic] phase and at least one reagent for the polycondensation reaction is present in the continuous [aqueous] phase.

In an embodiment, the process is as described above in which the reagents for the polycondensation reaction are only present in the dispersed phase.

In a preferred embodiment, the microcapsule formulation comprises microcapsules which comprise a compound of the first aspect dispersed in a (non-continuous) matrix, which is formed by an interfacial polycondensation reaction, and which compound is a solid at ambient temperature and is dispersed within a substantially water-immiscible liquid which is retained within the microcapsule, in which the microcapsules are dispersed in an aqueous phase, wherein at least one reagent for the polycondensation reaction is present in the dispersed [organic] phase and at least one reagent for the polycondensation reaction is present in the continuous [aqueous] phase.

In an embodiment, the active ingredient compound is one or more of acetamiprid, clothianidin, imidacloprid, dinotefuran, thiacloprid or thiamethoxam. Preferably, the compound is one or more of dinotefuran, clothianidin, imidacloprid or thiamethoxam, especially thiamethoxam.

In an embodiment, the active ingredient compound is dinotefuran.

In an embodiment, the active ingredient compound is thiamethoxam.

In an embodiment, the active ingredient compound is one or more of azoxystrobin, pyraclostrobin, fluoxastrobin, metominostrobin, trifloxystrobin or picoxystrobin; preferably one or more of azoxystrobin, pyraclostrobin, fluoxastrobin, trifloxystrobin or picoxystrobin; especially azoxystrobin.

In an embodiment, the active ingredient compound is one or more of a defined neonicotinoid and one or more of a strobilurin, such as thiamethoxam and azoxystrobin.

In a particular embodiment, the active ingredient compound defined in the first aspect has a water-solubility in the range of 0.1-100 g/l, preferably in the range 0.5-50 g/l, at 20° C.

The biologically active compound, preferably agrochemical, suitable for use in the present invention in the aqueous phase or water-immiscible liquid or further pesticidal products can be selected from fungicides, insecticides, nematicides, acaricides, and miticides.

Examples of suitable agrochemicals include those defined in the first aspect, organophosphorus compounds, nitrophenols and derivatives, formamidines, triazine derivatives, nitroenamine derivatives, nitro- and cyanoguanidine derivatives, ureas, benzoylureas, carbamates, pyrethroids, chlorinated hydrocarbons, benzimidazoles, strobilurins, triazoles, ortho-cyclopropyl-carboxanilide derivatives, phenylpyrroles, and Bacillus thuringiensis products.

Especially preferred agrochemicals include cyanoimine, acetamiprid, nitenpyram, clothianidin, dimethoate, dinotefuran, fipronil, flubendamide, lufenuron, pyripfoxyfen, thiacloprid, fluxofenime, imidacloprid, thiamethoxam, beta cyfluthrin, fenoxycarb, lamda cyhalothrin, diafenthiuron, pymetrozine, diazinon, disulphoton; profenofos, furathiocarb, cyromazin, cypermethrin, tau-fluvalinate, tefluthrin, chlorantraniliprole, Bacillus thuringiensis products, azoxystrobin; acibenzolor s-methyl, bitertanol; carboxin; Cu₂O; cymoxanil; cyproconazole; cyprodinil; dichlofluamid; difenoconazole; diniconazole; epoxiconazole; fenpiclonil; fludioxonil; fluoxastrobin, fluquiconazole; flusilazole; flutriafol; furalaxyl; guazatin; hexaconazole; hymexazol; imazalil; imibenconazole; ipconazole; kresoxim-methyl; mancozeb; metalaxyl; R metalaxyl; metconazole; myclobutanil, oxadixyl, pefurazoate; penconazole; pencycuron; picoxystrobin; prochloraz; probenazole, propiconazole; pyroquilone; SSF-109; spiroxamin; tebuconazole; tefluthrin; thiabendazole; trifloxystrobin, thiram, tolifluamide; triazoxide; triadimefon; triadimenol; trifloxystrobin, triflumizole; triticonazole, uniconazole, bixafen, fluopyram, a compound of formula A, a compound of formula B, and a compound of formula C

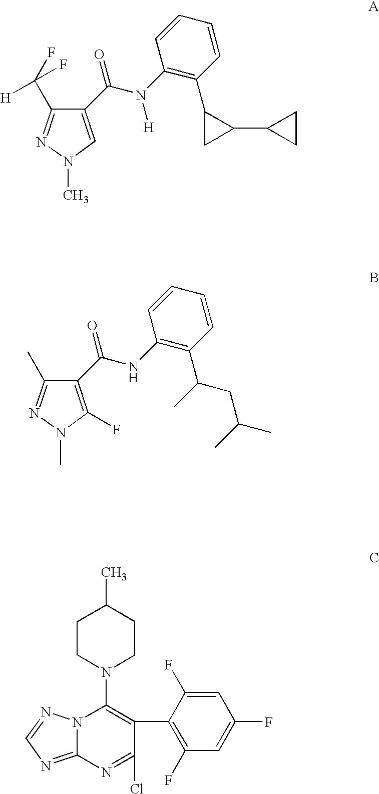

The rates of application (use) of an agrochemical varies, for example, according to type of use, type of crop, the density of the planting, the specific active ingredients in the composition, type of plant propagation material or plant but is such that the agrochemical is in an effective amount to provide the desired action (such as disease or pest control) and can be determined by trials.

Typically for drench application, the application rates can vary from 0.5 to 1000, preferably 5 to 750, more preferably 10 to 400, g AI/ha, including the compounds defined in the first aspect.

Generally for seed treatment, application rates can vary from 0.1 to 1000, preferably 0.5 to 500, more preferably 1 to 300, g AI/100 kg of seeds, including the compounds defined in the first aspect.

In general, the weight ratio between a compound defined in the first aspect and an agrochemical, in the instance they are different, would vary depending on the specific pesticide and how many pesticides are present in the composition. Generally, the weight ratio between a compound defined in the first aspect and an agrochemical is from 100:1 to 1:100, preferably from 75:1 to 1:75, more preferably, 50:1 to 1.50, especially 25:1 to 1:25, advantageously 10:1 to 1:10.

Each composition defined in the first aspect is especially advantageous for the treatment of plant propagation material.

In each aspect and embodiment of the invention, “consisting essentially” and inflections thereof are a preferred embodiment of “comprising” and its inflections, and “consisting of” and inflections thereof are a preferred embodiment of “consisting essentially of” and its inflections.

Use of a term in a singular form also encompasses that term in plural form and vice a versa.

The compounds of the first aspect and agrochemicals are active ingredients for use in the agrochemical industry (also known as pesticides). A description of their structure as well as the structures of other pesticides (e.g., fungicides, insecticides, nematicides) can be found in the e-Pesticide Manual, version 3.1, 13th Edition, Ed. CDC Tomlin, British Crop Protection Council, 2004-05.

The compounds of formula A and its manufacturing processes starting from known and commercially available compounds is described in WO 03/074491, WO 2006/015865 and WO 2006/015866.

The compound of formula B is described in WO 03/010149 and WO 05/58839.

A compound of formula C and its manufacturing processes starting from known and available compounds are described in EP-0975634 and U.S. Pat. No. 6,297,251.

The composition defined in the first aspect properties provides improved growing characteristics of a plant by, for example, higher than expected control of the pathogenic infestation and/or pest damage. However, the compositions surprisingly further demonstrate an improvement in the growth of a plant when the composition is applied at a rate (i) not sufficient to control the identified pest or pathogen pressure on the plant or (ii) greater than required to control the identified pest or pathogen pressure on the plant. In particular, the improvement in growth of a plant is achieved in the instance that there is no pest or pathogen pressure on the plant.

The improvement in the growing (or growth) characteristics of a plant can manifest in a number of different ways, but ultimately it results in a better product of the plant. It can, for example, manifest in improving the yield and/or vigour of the plant or quality of the harvested product from the plant, which improvement may not be connected to the control of diseases and/or pests.

As used herein the phrase “improving the yield” of a plant relates to an increase in the yield of a product of the plant by a measurable amount over the yield of the same product of the plant produced under the same conditions, but without the application of the subject method. It is preferred that the yield be increased by at least about 0.5%, more preferred that the increase be at least about 1%, even more preferred is about 2%, and yet more preferred is about 4%, or more. Yield can be expressed in terms of an amount by weight or volume of a product of the plant on some basis. The basis can be expressed in terms of time, growing area, weight of plants produced, amount of a raw material used, or the like.

As used herein the phrase “improving the vigour” of a plant relates to an increase or improvement of the vigour rating, or the stand (the number of plants per unit of area), or the plant height, or the plant canopy, or the visual appearance (such as greener leaf colour), or the root rating, or emergence, or protein content, or increased tillering, or bigger leaf blade, or less dead basal leaves, or stronger tillers, or less fertilizer needed, or less seeds needed, or more productive tillers, or earlier flowering, or early grain maturity, or less plant verse (lodging), or increased shoot growth, or earlier germination, or any combination of these factors, or any other advantages familiar to a person skilled in the art, by a measurable or noticeable amount over the same factor of the plant produced under the same conditions, but without the application of the subject method.

When it is said that the present method is capable of “improving the yield and/or vigour” of a plant, the present method results in an increase in either the yield, as described above, or the vigor of the plant, as described above, or both the yield and the vigor of the plant.

The composition defined in the first aspect may be applied directly to the plant, such as its foliage, applied to the plant propagation material, preferably before it is sown or planted, or locus thereof. In an embodiment, the composition is applied to the locus of the plant.

In an embodiment, the composition is applied to the plant propagation material, and then applied to the locus of the resulting plant.

The rates of application (use) of a compound of the first aspect can also vary, for example, according to type of use, type of crop, the density of the planting, the specific active ingredients in the composition, type of plant propagation material or plant but is such that the compound is in an effective amount to provide the desired action and can be determined by trials.

Typically for drench application, the application rates of thiamethoxam can vary from 10 to 500, preferably 25 to 300, more preferably 50 to 200, g AI/ha.

Generally for seed treatment, application rates of thiamethoxam can vary from 5 to 600, preferably 10 to 500, more preferably 15 to 300, g AI/100 kg of seeds, including the compounds defined in the first aspect.

It has been found that the capsule technology defined in the first aspect allow improved growth of a plant even in circumstances where the application rate is

(i) not sufficient to control the identified pest or pathogen pressure on the plant, or
(ii) greater than required to control the identified pest or pathogen pressure on the plant.

Further, the improved growth of a plant is achievable with the capsule technology defined in the first aspect even when no pest or pathogen pressure on the plant exists.

Suitable plants are cereals (wheat, barley, rye, oats, corn, rice, sorghum, triticale and related crops); beet (sugar beet and fodder beet); leguminous plants (beans, lentils, peas, soybeans); oil plants (rape, mustard, sunflowers); cucumber plants (marrows, cucumbers, melons); fibre plants (cotton, flax, hemp, jute); vegetables (spinach, lettuce, asparagus, cabbages, carrots, onions, tomatoes, potatoes, paprika); as well as ornamentals (flowers, shrubs, broad-leaved trees and evergreens, such as conifers). Especially suitable are wheat, barley, rye, oats, rice, sorghum, triticale, corn, and soybean.

Suitable plants also include transgenic plants of the foregoing types. The transgenic plants used according to the invention are plants, or propagation material thereof, which are transformed by means of recombinant DNA technology in such a way that they are—for instance—capable of synthesizing selectively acting toxins as are known, for example, from toxin-producing invertebrates, especially of the phylum Arthropoda, as can be obtained from Bacillus thuringiensis strains; or as are known from plants, such as lectins; or in the alternative capable of expressing a herbicidal or fungicidal resistance. Examples of such toxins, or transgenic plants which are capable of synthesizing such toxins, have been disclosed, for example, in EP-A-0 374 753, WO 93/07278, WO 95/34656, EP-A-0 427 529 and EP-A-451 878 and are incorporated by reference in the present application.

The application of the composition of the first aspect can result in a number of beneficial characteristics which vary with the plant and compound. Typically, the growth of the plant is improved, for example, in yield and/or vigour, and can demonstrate more tolerance to extreme temperature conditions (such as chilling effects, e.g., cold stress on corn) and stress factors (such as drought, soil salinity, heavy metals, ozone & atmospheric pollutants, high light conditions, etc), more flowing effects (such as improved synchronisation of flowering in a crop and increased flower number and/or colour uniformity and/or intensity), improved production of nutra-/pharmaceuticals, increased anthocyanins (sweet potato, apples, peach, raspberries), beta-carotene (tomato), increased flavonols and phenolics (strawberries), and improved colour in fruit (apples, mangoes, ornamentals), and/or more tolerance to phytotoxic substances such as herbicides, salt, etc,

The composition defined in the first aspect can be applied to the plant in a conventional manner, such as foliar spray or drench application. Advantageously, the composition are formulated for plant propagation material, such as seed, treatment applications.

Further, the invention also envisages soil application of the composition defined in the first aspect of the invention. Methods of applying to the soil can be via any suitable method, which ensures that the combination penetrates the soil, for example, nursery tray application, in furrow application, soil drenching, soil injection, drip irrigation, application through sprinklers or central pivot, incorporation into soil (broad cast or in band) are such methods.

The benefits from the invention can also be achieved either by (i) treating plant propagation material with a composition or (ii) applying to the locus where control is desired, generally the planting site, the composition, or both (i) and (ii).

The term “plant propagation material” is understood to denote all the generative parts of the plant, such as seeds, which can be used for the multiplication of the latter and vegetative plant materials such as cuttings and tubers (for example, potatoes).

Accordingly, as used herein, part of a plant includes propagation material. There may be mentioned, e.g., the seeds (in the strict sense), roots, fruits, tubers, bulbs, rhizomes, parts of plants. Germinated plants and young plants, which are to be transplanted after germination or after emergence from the soil, may also be mentioned. These young plants may be protected and/or aided, for example, against stress factors, before transplantation by a total or partial treatment by immersion.

Parts of plant and plant organs that grow at later point in time are any sections of a plant that develop from a plant propagation material, such as a seed. Parts of plant, plant organs, and plants can also benefit from the application of an active ingredient compound on to the plant propagation material. In an embodiment, certain parts of a plant and certain plant organs that grow at later point in time can also be considered as plant propagation material, which can themselves be applied (or treated) with an active ingredient compound; and consequently, the plant, further parts of the plant and further plant organs that develop from the treated parts of plant and treated plant organs can also benefit from the application of an active ingredient compound.

Methods for applying or treating pesticidal active ingredients and mixtures thereof on to plant propagation material, especially seeds, are known in the art, and include dressing, coating, pelleting and soaking application methods of the propagation material. In a preferred embodiment, the combination is applied or treated on to the plant propagation material by a method such that the germination is not induced; generally seed soaking induces germination because the moisture content of the resulting seed is too high. Accordingly, examples of suitable methods for applying (or treating) a plant propagation material, such as a seed, is seed dressing, seed coating or seed pelleting and alike.

It is preferred that the plant propagation material is a seed. Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications). The seed may also be primed either before or after the treatment.

Even distribution of the active ingredient(s) and adherence thereof to the seeds is desired during propagation material treatment. Treatment could vary from a thin film (dressing) of the formulation containing the active ingredient(s) on a plant propagation material, such as a seed, where the original size and/or shape are recognizable to an intermediary state (such as a coating) and then to a thicker film (such as pelleting with many layers of different materials (such as carriers, for example, clays; different formulations, such as of other active ingredients; polymers; and colourants) where the original shape and/or size of the seed is no longer recognisable.

An aspect of the present invention includes application of the active ingredient(s) onto the plant propagation material in a targeted fashion, including positioning the active ingredients onto the entire plant propagation material or on only parts thereof, including on only a single side or a portion of a single side. One of ordinary skill in the art would understand these application methods from the description provided in EP954213B1 and WO06112700.

Application of the active ingredient(s) described herein onto plant propagation material also includes protecting the plant propagation material treated with the active ingredient(s) by placing one or more pesticide-containing particles next to a pesticide-treated seed, wherein the amount of pesticide is such that the pesticide-treated seed and the pesticide-containing particles together contain an Effective Dose of the pesticide and the pesticide dose contained in the pesticide-treated seed is less than or equal to the Maximal Non-Phytotoxic Dose of the pesticide. Such techniques are known in the art, particularly in WO2005/120226.

The seed treatment occurs to an unsown seed, and the term “unsown seed” is meant to include seed at any period between the harvest of the seed and the sowing of the seed in the ground for the purpose of germination and growth of the plant.

Treatment to an unsown seed is not meant to include those practices in which the active ingredient is applied to the soil but would include any application practice that would target the seed during the planting process.

Preferably, the treatment occurs before sowing of the seed so that the sown seed has been pre-treated with the composition. In particular, seed coating or seed pelleting are preferred. As a result of the treatment, the active ingredients(s) in a composition are adhered on to the seed and therefore provide an improvement in the growing characteristics.

In another aspect, compounds defined in the first aspect, especially neonicotinoids, particularly thiamethoxam, can improve the growth, such as germination, yield, stand, etc, of a plant, especially when the plant or plant propagation material thereof is subjected to a stress indicator, for example, cold, drought, herbicide, salinity, etc, provided, however, that the propagation material of the plant (e.g. seed) has been treated with such a compound. In an embodiment, a corn seed treated with thiamethoxam germinates to yield a greater weight when a kept under a stress environment, such as cold conditions, for a period during its growth. Accordingly, the present invention also provides a method for improving the growth characteristics of a plant in non-optimal growing conditions comprising applying to a plant propagation material or locus thereof a compound defined in the first aspect, wherein the non-optimal growing conditions can be cold temperatures, drought, or salinity. In an embodiment, the non-optimal growing condition is a low temperature (e.g. about 10 C) and the growing plant is in this temperature zone for about 7 days, preferably from the planting or sowing of the seed. Thereafter, the temperature is increased to an optimal (e.g. about 25 C) temperature. Generally, seeds that are more susceptible to not germinating, especially at low temperatures, are able to still yield a product when such seeds are treated with a compound defined in the first aspect, such as neonicotinoids, particularly thiamethoxam.

The treated seeds can be stored, handled, sowed and tilled in the same manner as any other active ingredient treated seed.

The following examples are given by way of illustration and not by way of limitation of the invention, in which many microcapsule samples are characterised by their VMD [Volume Median Diameter].

### EXAMPLES 1a-1w

The following examples demonstrate that a suspension of thiamethoxam particles can be successfully encapsulated within polyurea microcapsules, the (non-continuous) matrix within the capsules being formed at ambient temperature from the reaction between essentially equimolar concentrations of isocyanate and amine moieties. Such formulations are not trivial to prepare successfully due to the high water-solubility of thiamethoxam (4.1 g/l at 20° C.) which means there is a tendency for the particles of thiamethoxam to migrate into the aqueous phase during the emulsification process, and/or during the formation of the (non-continuous) matrix.

Thiamethoxam is encapsulated using the following process according to the recipes given in Table 1. An organic phase is prepared by the addition of one or more isocyanates to a finely ground suspension of thiamethoxam in a substantially water immiscible solvent. This is emulsified into an aqueous solution of polyvinylalcohol to obtain the desired particle size. Then a solution of a polyfunctional amine is added, and the wall formation reaction is allowed to proceed at ambient temperature, maintaining gentle agitation throughout. Finally, postformulation (adjustment to neutral pH and addition of antisettling agents) is carried out as required.

Rapeseed oil (from Brassica rapa) was sourced from Fluka.

Solvesso® 200 is an aromatic hydrocarbon solvent supplied by Exxon.

Cropspray® 7N is a mineral oil supplied by Sun Oil Company.

Norpar® 15 and Prifer® 6813 are paraffinic solvents supplied by Exxon.

Solsperse® 17000 is a polymeric dispersant supplied by Lubrizol.

Z190-165™ is a polymeric dispersant supplied by Uniqema.

Agrimer® AL22 is an alkylated vinylpyrrolidone copolymer supplied by ISP.

Desmodur® Z4470 is the trimer of isophoronediisocyanate supplied by Bayer as a 70% solution in naphtha 100.

Desmodur® W is 4,4′-methylenebis(cyclohexyl isocyanate) supplied by Bayer.

TDI is an 80:20 mixture of tolylene 2,4- & 2,6-diisocyanate supplied by Sigma Aldrich.

Suprasec® 5025 (polymethylene polyphenylene isocyanate) is supplied by Huntsman.

Gohsenol® GL03, GL05 and GM14-L are polyvinylalcohols supplied by Nippon Gohsei.

Polyethyleneimine (Mn˜600 [Mn is number average molecular weight], M.Wt.˜800 Daltons) is supplied by Aldrich.

Avicel® CL611 is a microcrystalline cellulose supplied by FMC.

Kelzan® is a xanthan gum supplied by CP Kelco.

After sample preparation, each sample is characterised by measuring its VMD.

TABLE 1

| Component (g/l) | 1a | 1b | 1c | 1d | 1e | 1f | 1g | 1h |
|---|---|---|---|---|---|---|---|---|
| Thiamethoxam | 75 | 75 | 75 | 75 | 75 | 75 | 180 | 183.4 |
| Solsperse 17000 | 7.5 | 7.5 | 7.5 | 7.5 | 7.5 | 7.5 | 18 | 16.7 |
| Rapeseed oil | 86.3 | 86.3 | 86.3 | 86.3 | 78.2 | 78.2 | 205.7 | 175 |
| Desmodur Z4470 | 56.1 | 56.1 | 56.1 | 56.1 | 64.3 | 64.3 | 121.6 | 125 |
| SN | | | | | | | | |
| Gohsenol GL03 | 33.8 | 33.8 | 33.8 | 33.8 | 33.8 | 33.8 | 78.1 | 75 |
| Diethylenetriamine | 5.6 | 5.6 | 5.6 | 5.6 | 6.4 | 6.4 | 13.1 | 12.5 |
| Avicel CL611 | 10 | 10 | 10 | 10 | 10 | 10 | 10 | 10 |
| Water | To | To | To | To | To | To | To 1 | To 1 |
| | 1 litre | 1 litre | 1 litre | 1 litre | 1 litre | 1 litre | litre | litre |
| VMD/(μm) | 7.9 | 9.1 | 13.1 | 16.4 | 8.5 | 10.3 | 13.78 | 16.38 |

| Component (g/l) | 1i | | 1j | | 1k | | 1l | | 1m | |
|---|---|---|---|---|---|---|---|---|---|---|
| Thiamethoxam | 104 | | 75 | | 75 | | 75 | | 75 | |
| Solsperse 17000 | 5.4 | | 6.3 | | 6.3 | | 6.3 | | 6.3 | |
| Rapeseed oil | 69 | | — | | — | | — | | — | |
| Solvesso 200 | — | | 91.3 | | 91.3 | | 91.3 | | 93.5 | |
| Desmodur Z4470 SN | 69 | | — | | — | | — | | — | |
| Suprasec 5025 | — | | 30.9 | | 31.0 | | 31.0 | | 19.5 | |
| Gohsenol GL03 | 48.5 | | — | | — | | — | | — | |
| Gohsenol GL05 | — | | 21.9 | | 15.6 | | 15.6 | | 14.7 | |
| Diethylenetriamine | 7.0 | | — | | — | | — | | — | |
| 1,6-diamino-n-hexane | — | | 14.5 | | — | | — | | — | |
| Ethylene-1,2-diamine | — | | — | | 7.6 | | — | | — | |
| Tetraethylenepentamine | — | | — | | — | | 9.4 | | 6 | |
| Avicel CL611 | 8.5 | | 10 | | 10 | | 15 | | 8 | |
| Kelzan | — | | — | | — | | — | | 2 | |
| Water | To 1 litre | | To 1 litre | | To 1 litre | | To 1 litre | | To 1 litre | |
| VMD/(μm) | 11 | | 6.6 | | 13.2 | | 10.8 | | 14.1 | |
| Component (g/l) | 1n | 1o | 1p | 1q | 1r | 1s | 1t | 1u | 1v | 1w |
| Thiamethoxam | 75 | 75 | 75 | 75 | 75 | 120 | 120 | 120 | 120 | 75 |
| Z190-165 | 18.8 | — | — | — | — | — | — | — | — | — |
| Agrimer AL22 | — | 7.5 | 7.5 | 7.5 | 7.5 | 12 | 12 | 12 | 12 | 7.5 |
| Prifer 6813 | 27.5 | — | — | — | — | — | — | — | — | — |
| Norpar 15 | 27.5 | — | — | — | — | — | — | — | — | — |
| Cropspray 7N | — | 67.5 | 67.5 | 67.5 | 67.5 | 108 | 108 | 108 | 108 | 67.5 |
| Desmodur Z4470 SN | 38.2 | — | — | — | — | — | — | — | — | — |
| Desmodur W | — | 26.5 | 12.2 | — | — | 60 | — | 102 | 42.3 | 16.7 |
| TDI | — | — | — | 26.5 | 26.5 | — | 26.7 | — | — | — |
| Gohsenol GL03 | 16 | — | — | — | — | — | — | — | — | — |
| Gohsenol GL05 | — | 20 | 20 | 20 | 20 | 37.5 | 32.1 | 28.9 | 32.1 | 20.1 |
| Gohsenol GM14-L | — | 6.7 | 6.7 | 6.7 | 6.7 | 12.5 | 10.7 | 9.7 | 10.7 | 13.4 |
| Diethylenetriamine | 2.7 | 3.8 | 3.3 | 11.5 | — | — | — | — | — | 4.8 |
| Tetraethylenepentamine | — | 4.2 | — | — | 11.7 | — | 11.8 | 30.6 | 12.6 | — |
| Polyethyleneimine | — | — | — | — | — | 60.8 | — | — | — | — |
| Avicel CL611 | 10 | 10 | 10 | 10 | 10 | — | 5 | 5 | 5 | 10 |
| Water | To | To | To | To | To | To 1 | To | To | To | To |
| | 1 litre | 1 litre | 1 litre | 1 litre | 1 litre | litre | 1 litre | 1 litre | 1 litre | 1 litre |
| VMD/(μm) | 18.8 | 15 | 12 | 8.2 | 16.3 | 9.8 | 11.9 | 9.0 | 13.3 | 102 |

### EXAMPLES 2a-2d

The following examples demonstrate that a suspension of thiamethoxam particles can be encapsulated within polyurea microcapsules, the (non-continuous) matrix within the capsules being formed by a combination of isocyanate hydrolysis and self-condensation, and the reaction between isocyanate and amine moieties is added through the aqueous phase. In these examples the molar ratio of the externally added amine:isocyanate moieties is significantly lower than 1:1. Such formulations are particularly difficult to prepare successfully due to the elevated temperatures utilised during the formation of the (non-continuous) matrix; it is important that a shell is fixed around the outside of the emulsion droplets via initial reaction between the amine moieties and some of the isocyanate moieties to prevent excessive migration of thiamethoxam particles into the aqueous phase.

Thiamethoxam is encapsulated using the following process according to the recipes given in Table 2. An organic phase is prepared by the addition of one or more isocyanates to a finely ground suspension of thiamethoxam in a substantially water immiscible solvent. This is emulsified into an aqueous solution of polyvinylalcohol to obtain the desired particle size. Then a solution of a polyfunctional amine is added, the temperature of the emulsion is raised to 40° C. and this temperature is maintained for 3 hours to allow the wall formation reaction to proceed, maintaining gentle agitation throughout. Finally, post-formulation (adjustment to neutral pH and addition of antisettling agents) is carried out as required.

Each sample is then characterised by measuring its VMD.

TABLE 2

| Component (g/l) | 2a | 2b | 2c | 2d |
|---|---|---|---|---|
| Thiamethoxam | 75 | 75 | 75 | 75 |
| Solsperse 17000 | 6.3 | 6.3 | 6.3 | 6.3 |
| Solvesso 200 | 83.7 | 83.7 | 73.9 | 73.9 |
| TDI | 14.6 | 14.6 | 19.5 | 19.5 |
| Suprasec 5025 | 14.6 | 14.6 | 19.5 | 19.5 |
| Gohsenol GL05 | 14.7 | 14.7 | 14.7 | 14.7 |
| 1,6-diamino-n-hexane | 3.1 | 3.1 | 4.2 | 4.2 |
| Avicel CL611 | 8 | 8 | 8 | 8 |
| Kelzan | 2 | 2 | 2 | 2 |
| Water | To 1 litre | To 1 litre | To 1 litre | To 1 litre |
| VMD/(μm) | 10.5 | 16.2 | 13.0 | 22.8 |

### EXAMPLE 3

The following example demonstrates the combination of an encapsulated suspension of thiamethoxam with a suspension of unencapsulated thiamethoxam in the aqueous phase. Microcapsules containing a suspension of thiamethoxam are prepared according to the method detailed in example 1, according to the composition in Table 3. The capsule formulation is characterised by measuring its VMD. The microcapsules are then mixed in various ratios with Cruiser™ 350FS (a suspension concentrate containing 350 g/l thiamethoxam) to give final products with ratios of encapsulated to unencapsulated thiamethoxam of 1:1, 1:2 and 2:1 by weight (examples 3a, 3b and 3c respectively).

TABLE 3

| Component (g/l) | |
|---|---|
| Thiamethoxam | 75 |
| Solsperse 17000 | 7.5 |
| Rapeseed oil | 78.2 |
| Desmodur Z4470 SN | 64.3 |
| Gohsenol GL03 | 33.1 |
| Diethylenetriamine | 6.3 |
| Avicel CL611 | 10 |
| Water | To 1 litre |
| VMD/(μm) | 26.4 |

### EXAMPLE 4

The following example demonstrates that microcapsules comprising a suspension of thiamethoxam particles can be spray dried to give a dry granular product. Microcapsules comprising a suspension of thiamethoxam particles are prepared according to the method described in Example 1, using water plus the ingredients given in the recipe of Table 4 below [later the water was removed to give a formulation having the recipe of Table 4]. Then this microcapsule suspension is mixed with an aqueous solution of polyacrylic acid (MW 2000), dextrin and Polyfon™ T (sodium lignosulfonate supplied by MeadWestvaco) to give a spray slurry. The slurry is spray dried in a Pepit™ WG4 spray drier to give a dry granular product with the following composition:

TABLE 4

| Component (% w/w) | |
|---|---|
| Components present in CS formulation | |
| Thiamethoxam | 30 |
| Solsperse 17000 | 1.98 |
| Rapeseed oil | 20.55 |
| Desmodur Z4470 SN | 16.94 |
| Gohsenol GL05 | 8.91 |
| Diethylenetriamine | 1.69 |
| Avicel CL611 | 2.63 |
| Components added in spray slurry | |
| Polyacrylic acid (MW2000) | 7.72 |
| Polyfon T | 6.67 |
| Dextrin | 13.13 |

### EXAMPLE 5

The following example demonstrates the improved plant growth of a capsule technology of Example 1w (a capsule suspension formulation of the invention) compared to a wettable granule formulation of thiamethoxam.

Planted pots are grown with cabbage (4 weeks old). The treatment is performed by drench application of 60 ml of the formulated AI solution to each soil pot containing 400 ml of soil at a rate of 12.5 ppm AUL soil. Plants are kept in the glasshouse (25±1° C., ca. 60% r.h. and 16 h light). Irrigation is done on demand avoiding any outpouring. The plants are harvested with certain time intervals. The fresh weight of all leaves is determined right after cutting close to soil surface.

Table 1 below provides the results of fresh weight

TABLE 1

Fresh weight (g)

| | 28DAA | 42DAA |
|---|---|---|
| Check | 30.0 | 45.5 |
| Thiamethoxam in a WG formulation | 35.3 | 54.0 |
| Thiamethoxam in example 1w | 39.0 | 59.3 |

1. A method of improving the growth of a plant comprising applying to a plant, plant propagation material or locus thereof a composition comprising a product, which comprises microcapsules which themselves comprise
(a) a polymeric shell; and
(b) a core which comprises a dispersed solid active ingredient compound
wherein the compound is one or more of a neonicotinoid, fipronil, a strobilurin, carboxin, acibenzolar-S-methyl, and probenazole.

2. The method according to claim 1 wherein the a core comprises (i) an active ingredient compound dispersed in a matrix and (ii) a water-immiscible liquid characterised in that the matrix is distributed non-continuously throughout the water-immiscible liquid; wherein the compound is one or more of a neonicotinoid, fipronil, a strobilurin, carboxin, acibenzolar-5-methyl, and probenazole.

3. The method according to claim 1 wherein the microcapsules are dispersed in an aqueous phase.

4. The method according to claim 1 wherein the product is a dry product.

5. The method according to claim 4 wherein the dry product is granular.

6. The method according to claim 4 wherein the dry product is water-dispersible.

7. The method according to 3 wherein the aqueous phase comprises an agrochemical.

8. The method according to claim 7 wherein the active ingredient compound in the core is same or different from the agrochemical in the aqueous phase.

9. The method according to claim 1 wherein the water-immiscible liquid is or comprises an agrochemical.

10. The method according to claim 1 wherein the active ingredient compound is one or more of acetamiprid, clothianidin, imidacloprid, dinotefuran, thiacloprid or thiamethoxam.

11. The method according to claim 1 wherein the active ingredient compound is one or more of azoxystrobin, pyraclostrobin, fluoxastrobin, metominostrobin, trifloxystrobin or picoxystrobin.

12. The method according to claim 1 wherein the active ingredient compound is one or more of fipronil, carboxin, acibenzolar-S-methyl, or probenazole.

13. The method according to claim 1 wherein the matrix is a polymer which is a polyurea, a polyamide or a polyurethane or is a mixture of two or more of these polymers.

14. The method according to claim 13 wherein the matrix is a polyurea.

15. The method according to claim 1 wherein the polymeric shell is a polymer which is a polyurea, a polyamide or a polyurethane or is a mixture of two or more of these polymers.

16. The method according to claim 15 wherein the polymeric shell is a polyurea.

17. The method according to claim 1 wherein the water-immiscible liquid has a water solubility of less than or equal to 5000 ppm by weight at 20° C.

18. The method according to claim 6 wherein the agrochemical is one or more agrochemical selected from fungicides, insecticides, nematicides, acaricides, and miticides.

19. The method according to claim 1 wherein the plant is selected cereals; beet; leguminous plants; oil plants; cucumber plants; fibre plants; vegetables; and ornamentals.

20. The method according to claim 1 wherein the improving the growth comprises improving the yield of the plant.

21. The method according to claim 1 wherein the improving the growth comprises improving the vigour of the plant.

22. The method according to claim 1 wherein the composition is applied to the plant propagation material.

23. The method according to claim 1 wherein the composition comprises one or more further pesticidal products comprising one or more other agrochemicals.

24. The method according to claim 23 wherein the agrochemical is selected a fungicide, insecticide, nematicide, acaricide, and miticide.

25. The method according to claim 1 wherein the plant is a genetically modified plant.

26. The method according to claim 1 wherein the composition is applied at a rate (i) not sufficient to control the identified pest or pathogen pressure on the plant or (ii) greater than required to control the identified pest or pathogen pressure on the plant.

27. The method according to claim 1 wherein the there is no pest or pathogen pressure on the plant.
